(19) United States
(12) Patent Application Publication
(10) Pub. No.: US 2026/0247282 A1
(43) Pub. Date: Aug. 20, 2026

(54) WAKE TIME NEGOTIATION IN A LOW-RATE WIRELESS PERSONAL AREA NETWORK

(71) Applicant: QUALCOMM Incorporated, San Diego, CA (US)

(72) Inventors: Prem Sundar ARUMUGUM, Hyderabad (IN); Selvam GOPAL, Karur (IN)

(21) Appl. No.: 19/057,434

(22) Filed: Feb. 19, 2025

(51) Int. Cl. H04W 52/02; H04W 84/18

(52) U.S. Cl. CPC H04W 52/0216; H04W 52/0219; H04W 84/18

(57) ABSTRACT

Disclosed are some examples of wake time negotiation in a low-rate wireless personal area network (LR-WPAN). For instance, following establishment of a LR-WPAN association between a coordinator and an end device, the coordinator can transmit an initiator communication indicating at least an enablement of the wake time negotiation. The end device can transmit a responder communication indicating at least: the enablement of the wake time negotiation, and a feasible timeframe for the end device to participate in a data transaction with the coordinator. The coordinator can then determine an intended service timeframe to participate in the data transaction with the end device. After scheduling the intended service timeframe, the coordinator can transmit a communication indicating at least the scheduled service timeframe. Such a schedule-based wake time negotiation can allow both the coordinator and the end device to save significant power by going to sleep during non-service timeframes.

### BACKGROUND

### 1. Field of Disclosure

The present disclosure relates generally to the field of wireless communications, and more specifically to communications between devices using a low-rate wireless personal area network (LR-WPAN).

### 2. Description of Related Art

Wireless personal area networks (WPANs) are used for device-to-device communication and are defined by Institute of Electrical and Electronics Engineers (IEEE) 802.15 standards. WPANs can be configured to use different radio access technologies (RATs) including Bluetooth “classic,” Bluetooth low-energy (BLE) (or Bluetooth Smart), Bluetooth long-range (BLR), Z-Wave, wireless USB, body area networks (e.g., comprised of wearable computing devices), and so on. IEEE 802.15.4 defines standards for LR-WPAN RATs such as Zigbee, ISA100.11a, WirelessHART, MiWi, SNAP and Thread.

### BRIEF SUMMARY

Disclosed are some examples of wake time negotiation between devices in a LR-WPAN. For instance, following establishment of a LR-WPAN association between a coordinator and an end device, the coordinator can transmit an initiator communication indicating at least an enablement of the wake time negotiation. The end device can transmit a responder communication indicating at least: enablement of the wake time negotiation, and a feasible timeframe for the end device to participate in a data transaction with the coordinator. The coordinator can then determine an intended service timeframe to participate in the data transaction with the end device. After scheduling the intended service timeframe, the coordinator can transmit a communication indicating at least the scheduled service timeframe. Such a schedule-based wake time negotiation can allow both the coordinator and the end device to save significant power by going to sleep during non-service timeframes.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIGS. 1A and 1B are diagrams showing examples of different LR-WPAN topologies for some implementations.

FIG. 2 is a timing diagram 200 showing techniques for wake time negotiation in both beacon enabled and non-beacon enabled LR-WPANs, according to some implementations.

FIG. 3A is a diagram showing an example of a format of an initiator frame 300A.

FIG. 3B is a diagram showing an example of a format of a responder frame 300B.

FIG. 4 is a timing diagram 400 showing techniques for wake time negotiation in both beacon enabled and non-beacon enabled LR-WPANs, according to some implementations.

FIG. 5 is a diagram showing an example of a service schedule 500 in the form of a matrix table.

FIG. 6 is a flow diagram of a coordinator-implemented method 600 of wake time negotiation in a LR-WPAN, according to some implementations.

FIG. 7 is a flow diagram of an end device-implemented method 700 of wake time negotiation in a LR-WPAN, according to some implementations.

FIG. 8 is a block diagram of an example of an end device 1100, which can be utilized in some implementations.

FIG. 9 is a block diagram of an example of a coordinator 1200, which can be utilized in some implementations.

FIG. 10 is a block diagram of an example of a computer system 1300, which can be utilized in some implementations.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as the Institute of Electrical and Electronics Engineers (IEEE) 802.15.4 standards, including Smart Utility Networks (SUN).

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

In some commercial and smart utility network environments based on LR-WPANs, one or more end devices communicate with a coordinator. Such end devices often have limited battery capacity, so it is desirable to save power where possible.

LR-WPANs can be beacon enabled or non-beacon enabled, as will be appreciated by those skilled in the art. A beacon enabled mode refers to a network where a coordinator periodically transmits beacon signals to synchronize other devices in the network, allowing for power management and scheduling. A non-beacon enabled mode involves operation without these beacons, meaning devices actively search for each other to communicate, resulting in less power efficiency but potentially more flexibility in network topology.

In a beacon enabled LR-WPAN, it is possible to configure an end device to go to sleep and wait for a beacon outside of a data exchange with a coordinator. However, the sleep time of the end device is limited using conventional power saving techniques associated with IEEE 802.15.4 standards. This is because there is a maximum number of beacons the end device can miss, currently 4 beacons, before having to go through a time-consuming resync process with the coordinator. Thus, with conventional 802.15.4 power saving techniques in beacon enabled LR-WPANs, the end device is configured to periodically wake from a sleep state to reduce the risk of missing more than 4 beacons. Periodic wake-up from sleep consumes significant power, especially for low battery capacity end devices.

Conventional techniques for saving power in non-beacon enabled LR-WPANs can present unreliability in the form of an orphan problem. If any communication failure occurs between the coordinator and the end device, the end device is considered orphaned from the LR-WPAN and has to go through a time-consuming orphan realignment process to reconnect to the LR-WPAN.

Various aspects of this disclosure relate generally to wake time negotiation between devices in a LR-WPAN. In some examples, following establishment of a LR-WPAN connection or other type of association between a coordinator and an end device, a coordinator and an end device exchange communications to negotiate and schedule an intended service timeframe for a data transaction to occur between the coordinator and the end device. For instance, the coordinator can transmit an initiator communication indicating at least that wake time negotiation is enabled at the coordinator. The end device can transmit a responder communication indicating at least: that wake time negotiation is enabled at the end device, and a feasible timeframe for the end device to participate in a data transaction with the coordinator. The coordinator can then determine an intended service timeframe to participate in the data transaction with the end device. After scheduling the intended service timeframe, the coordinator can transmit a communication indicating at least the scheduled service timeframe.

Particular aspects of the subject matter described in this disclosure can be implemented to realize one or more of the following potential advantages. In some examples, by performing wake time negotiation, the described techniques can be used by a coordinator and an end device to determine specific times for the end device and even the coordinator to enter and wake from a low-power state such as a sleep mode and transmit or receive data. For example, some of the disclosed techniques can allow end devices in some environments to wake only once or twice a day at designated times, significantly reducing the power consumption associated with more frequent wake-ups while minimizing the risk of connectivity failures.

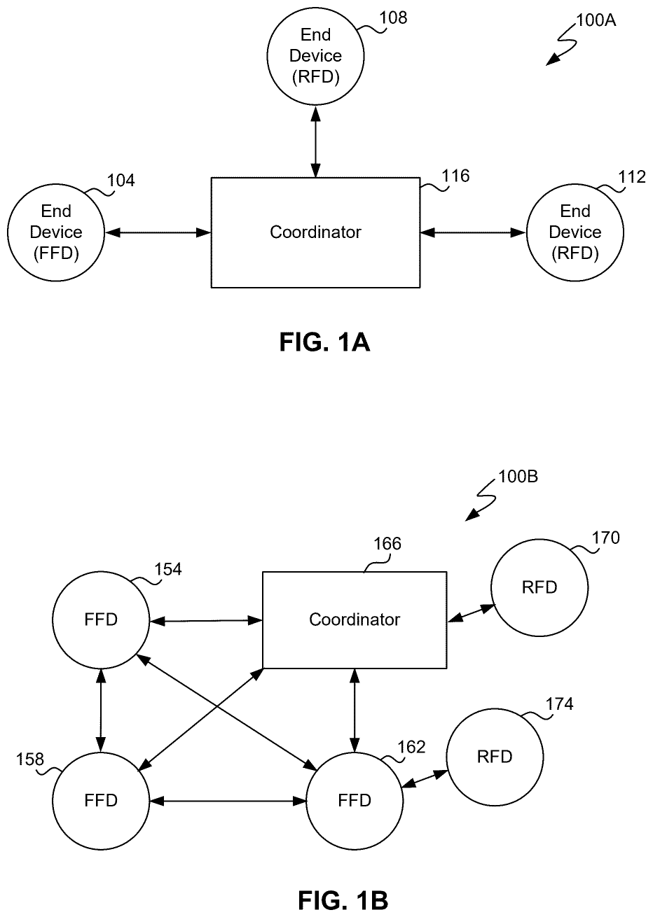

FIGS. 1A and 1B are diagrams showing examples of different LR-WPAN topologies for some implementations. FIG. 1A is a diagram showing an example of a star topology 100A, in which a number of end devices including end device 104, end device 108 and end device 112 communicate with a central coordinator 116. In this example, end devices 108 and 112 are reduced function devices (RFDs), while end device 104 is a full function device (FFD). Those skilled in the art will appreciate that an FFD is capable of carrying out a variety of network capabilities including acting as a coordinator in some other implementations. An RFD is a relatively simpler device with limited capabilities and is controlled by coordinator 116. Examples of RFDs include low power devices such as battery-powered devices, as will be appreciated by those skilled in the art.

FIG. 1B is a diagram showing an example of a peer-to-peer topology 100B, in which a number of FFDs including FFD 154, FFD 158 and FFD 162 directly communicate with each other and with a coordinator 166. Thus, nodes represented by the FFDs and coordinator 166 in FIG. 1B can exchange communications without needing to go through a central hub. In this example, coordinator 166 also directly communicates with and controls an RFD 170, while FFD 162 directly communicates with and controls an RFD 174. As in FIG. 1A, any of the FFDs in FIG. 1B can be configured as a coordinator according to different implementations.

In the examples of FIGS. 1A and 1B, the coordinators and end devices including FFDs and RFDs are configured to operate according to IEEE 802.15.4 standards associated with LR-WPANs. IEEE 802.15.4 specifies low cost wireless links relevant to a number of industrial and/or commercial sensor applications. 802.15.4 defines physical (PHY) layer and medium access control (MAC) sublayer specifications for low data rate wireless connectivity with fixed, portable, and moving devices with no battery consumption or limited battery consumption. In some disclosed implementations based on 802.15.4, low complexity, low cost, low power consumption and low data rate wireless connectivity can be obtained among inexpensive devices, especially in internet of things (IoT) applications.

Some disclosed implementations can be practiced in both beacon enabled and non-beacon enabled LR-WPANs to achieve more efficient data transfer and reduced power consumption, especially in 802.15.4 applications.

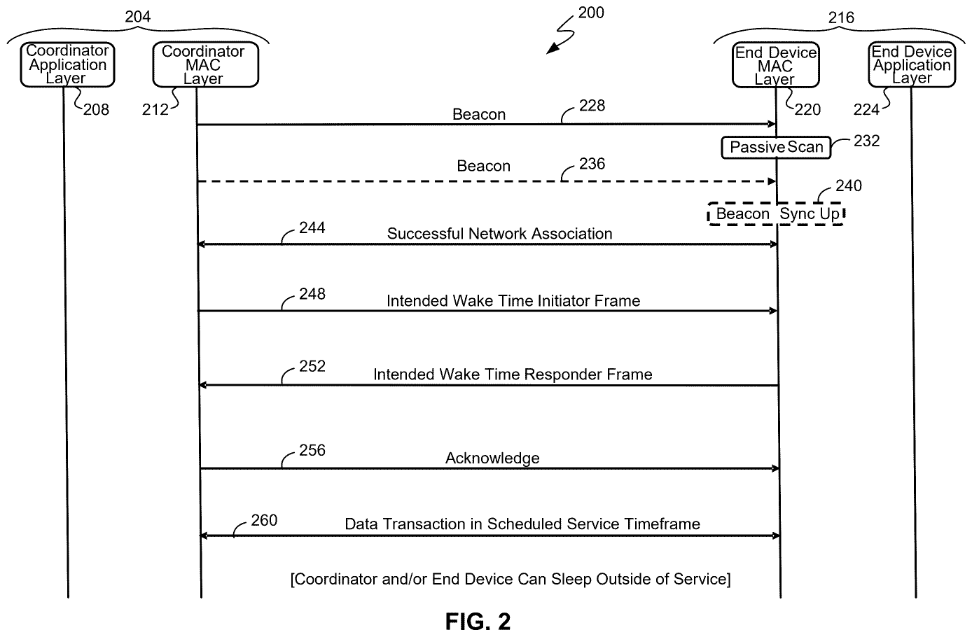

FIG. 2 is a timing diagram 200 showing techniques for wake time negotiation in both beacon enabled and non-beacon enabled LR-WPANs, according to some implementations. In FIG. 2, when a coordinator 204 having a coordinator application layer 208 and a coordinator MAC layer 212 is ready to transfer data to an end device 216 including an end device MAC layer 220 and an end device application layer 224, coordinator 204 indicates in a beacon 228 that a data message is pending. End device 216 is listening for the beacon by performing a passive scan operation at 232. In beacon enabled implementations, when end device 216 is ready to transfer data to coordinator 204, end device 216 listens for a beacon 236. When beacon 236 is detected by end device 216, end device 216 synchronizes to a frame structure by performing a beacon sync up operation at 240.

In FIG. 2, following beacon sync up at 240 in the case of beacon enabled implementations, or following passive scan at 232 in the case of non-beacon enabled implementations, a LR-WPAN association is successfully established between coordinator 204 and end device 216, at 244 in these examples.

In FIG. 2, following establishment of the network association, coordinator 204 transmits an initiator communication including an initiator frame indicating at least an enablement of the wake time negotiation, at 248. End device 216 can then process the initiator communication, including determining that the initiator communication indicates enablement of the wake time negotiation. At 252, end device 216 transmits a responder communication including a responder frame also indicating enablement of the wake time negotiation. Coordinator 204 receives the responder communication and can perform additional processing operations, as explained herein.

In FIG. 2, coordinator 204 then determines an intended service timeframe to participate in a data transaction with end device 216 and schedules the intended service timeframe, as further described herein. At 256, coordinator 204 transmits a coordinator acknowledgment communication indicating at least the scheduled service timeframe. At 260, coordinator 204 can then participate in the data transaction with end device 216 during the scheduled service timeframe.

By negotiating in the manner of FIG. 2 and other examples herein, each of controller 204 and end device 216 can be configured to maximize sleep outside of the scheduled service timeframe. For instance, end device 216 can enter into a sleep mode from an awake mode immediately after receiving the coordinator acknowledgment communication at 256 and can schedule the end device's wake-up immediately before the data transaction is to occur. Coordinator 204 can even be programmed to go to sleep after transmitting the acknowledgement communication at 256. Also or alternatively, end device 216 and coordinator 204 can enter into sleep mode immediately after the scheduled service timeframe.

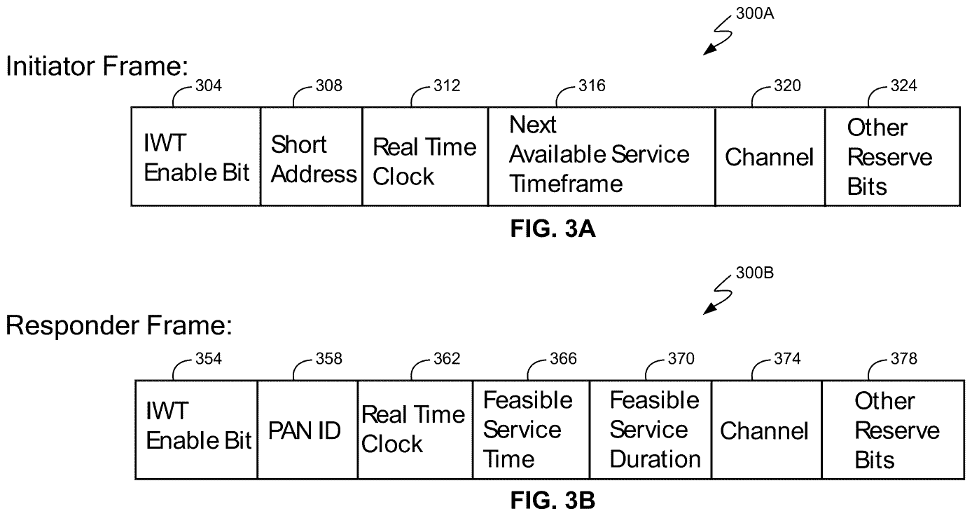

FIG. 3A is a diagram showing an example of a format of an initiator frame 300A. In FIG. 3A, initiator frame 300A includes an intended wake time (IWT) enable bit 304 which can be set to indicate whether a coordinator has enabled the wake time negotiation. Initiator frame 300A further includes: a short address 308 indicating a network address of the coordinator, coordinator clock data 312, a next available service timeframe 316 for the coordinator to participate in the data transaction, and a desired communication channel 320. Initiator frame 300A can be further configured with reserve bits 324.

FIG. 3B is a diagram showing an example of a format of a responder frame 300B. In FIG. 3B, responder frame 300B includes an IWT enable bit 354 which can be set to indicate whether an end device has enabled the wake time negotiation. Responder frame 300B further includes: a network identifier (ID) 358 indicating a network address of the end device, end device clock data 362, a feasible service timeframe for the end device to participate in the data transaction, and a desired communication channel 374. In this example, the feasible service timeframe for the end device is represented by a feasible time 366 and a feasible duration 370. Responder frame 300B can be further configured with reserve bits 378.

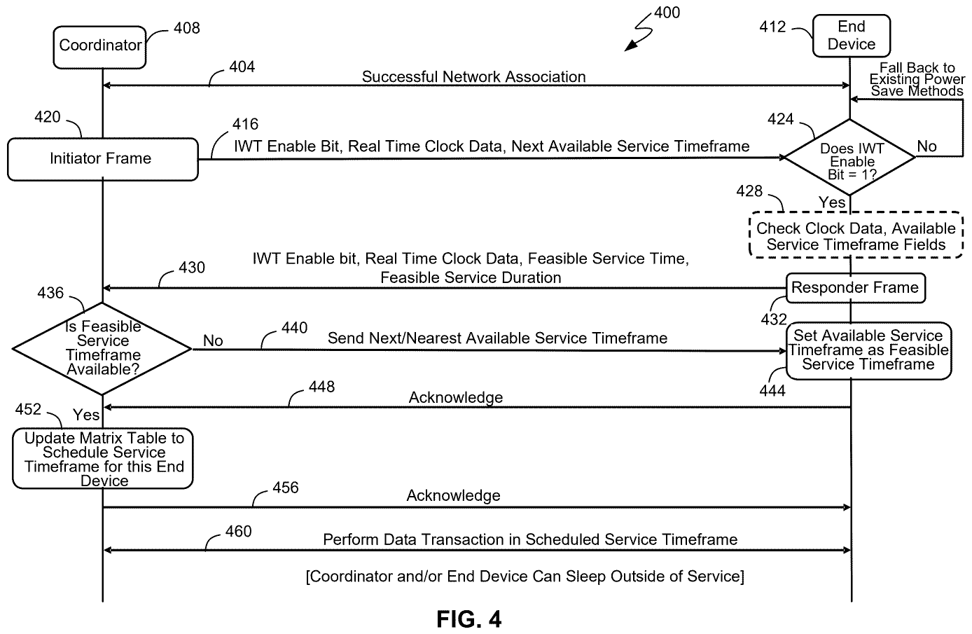

FIG. 4 is a timing diagram 400 showing techniques for wake time negotiation in both beacon enabled and non-beacon enabled LR-WPANs, according to some implementations. At 404, a LR-WPAN association between a coordinator 408 and an end device 412 is successfully established. Following this network association, at 416, coordinator 408 transmits an initiator communication including an initiator frame 420 indicating that coordinator 408 has enabled the wake time negotiation. In this example, initiator frame 420 includes fields 304-324 of initiator frame 300A of FIG. 3A.

In FIG. 4, end device 412 processes the initiator communication, including determining whether initiator frame 420 indicates enablement of the wake time negotiation for coordinator 408. In this example, this determination includes checking at 424 whether IWT enable bit 304 has a value of ‘1’ or ‘0.’ In this example, a ‘1’ indicates that wake time negotiation is enabled, while a ‘0’ indicates that wake time negotiation is not enabled. Detection of a ‘0’ at 424 can cause end device 412 to wait for a future initiator frame with an IWT enable bit of ‘1.’

In FIG. 4, when a ‘1’ is detected at 424, optional additional processing of initiator frame 420 is performed by end device 412 at 428, including one or more of: detecting coordinator address 308, recognizing clock data 312, detecting next available service timeframe 316, and recognizing channel 320 for future communications with coordinator 408. When this optional additional processing of initiator frame 420 is performed, clock data 312 (coordinator) can be compared with clock data 362 (end device) for the purpose of syncing a clock of end device 412. In addition, next available service timeframe 316 can be compared with the end device's feasible service timeframe. When there is no conflict, the feasible service timeframe can be set to match next available service timeframe 316.

In FIG. 4, after 428, end device 412 generates and transmits at 430 a responder communication including a responder frame 432 indicating at least enablement of the wake time negotiation for end device 412, as well as the feasible service timeframe for the end device to participate in a data transaction with coordinator 408. In this example, responder frame 432 includes fields 354-378 of responder frame 300B of FIG. 3B.

In FIG. 4, when coordinator 408 receives the responder communication, coordinator 408 can process responder frame 432 to determine whether end device 412 has enabled wake time negotiation. If so, coordinator 408 can detect, in responder frame 432, the feasible service timeframe for end device 412, as well as one or more of: network ID 358, clock data 362 and desired communication channel 374 of FIG. 3B.

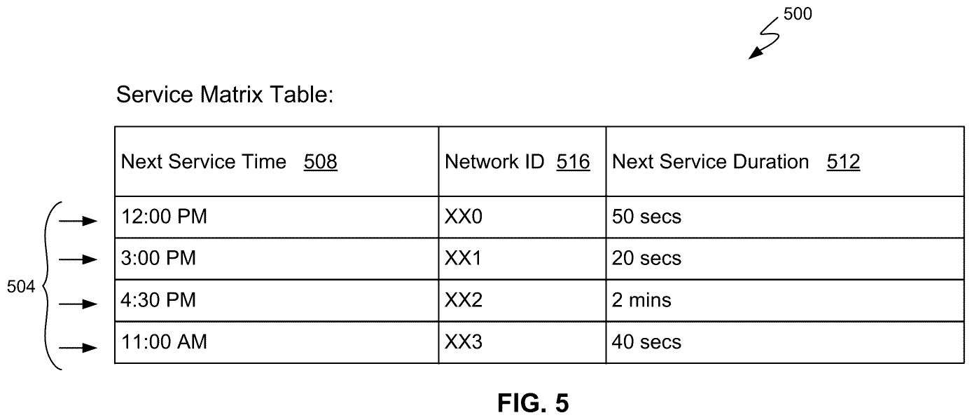

In FIG. 4, determining an intended service timeframe by coordinator 408 can include determining, at 436, whether the feasible service timeframe of responder frame 432 is available. In some implementations, this determination by coordinator 408 includes checking a service schedule maintained in a memory that tracks a number of scheduled service timeframes for a number of end devices having the LR-WPAN association with coordinator 408, as described in greater detail below with reference to FIG. 5. When the feasible service timeframe is unavailable, coordinator 408 can use the service schedule to find an available service timeframe such as a nearest or next available time slot in the service schedule and transmit, at 440, an available service communication indicating the available service timeframe. End device 412 can check whether this available service timeframe is available for end device 412 and, if so, update the end device's feasible service timeframe to match the intended service timeframe at 444.

End device 412 can then transmit, at 448, an end device acknowledgement communication indicating acceptance of the available service timeframe. When coordinator 408 receives the end device acknowledgement communication, coordinator 408 can update the coordinator's intended service timeframe to match the available service timeframe. At 452, coordinator 408 can schedule the intended service timeframe for the end device, including updating the service schedule of FIG. 5. Coordinator 408 can then transmit, at 456, a coordinator acknowledgment communication indicating at least the scheduled service timeframe. At 460, coordinator 408 and end device 412 can then participate in the data transaction during the scheduled service timeframe.

In some implementations, such as with FIG. 2 and FIG. 4, an end device and/or a coordinator can be programmed or otherwise configured to enter into a sleep mode from an awake mode. For instance, this can occur after the coordinator acknowledgment communication at 456. The end device and/or the coordinator can be programmed or otherwise configured to enter into the sleep mode from the awake mode at times outside of the scheduled service timeframe, and one or more wake-up events can be scheduled for the end device and/or the coordinator based on the scheduled service timeframe to maximize power conservation.

FIG. 5 is a diagram showing an example of a service schedule 500 in the form of a matrix table. In this example, service schedule 500 is maintained in a memory by a coordinator and identifies scheduled service timeframes for a number of end devices associated with the coordinator. For instance, scheduled service timeframes can be identified by respective rows 504 in the matrix table and can be implemented to include a next service time 508 and a next service duration 512 for each row. In this example, each of the rows 504 corresponds to a different end device having a corresponding network ID 516. Determining the intended service timeframe for the coordinator to participate in the data transaction with the end device can include determining whether the feasible service timeframe is available using the service times and durations maintained in service schedule 500 of FIG. 5.

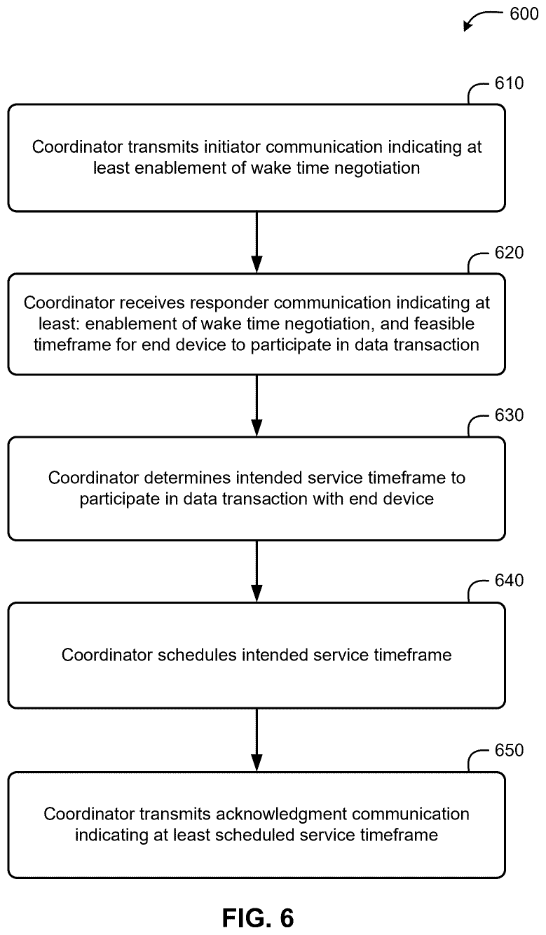

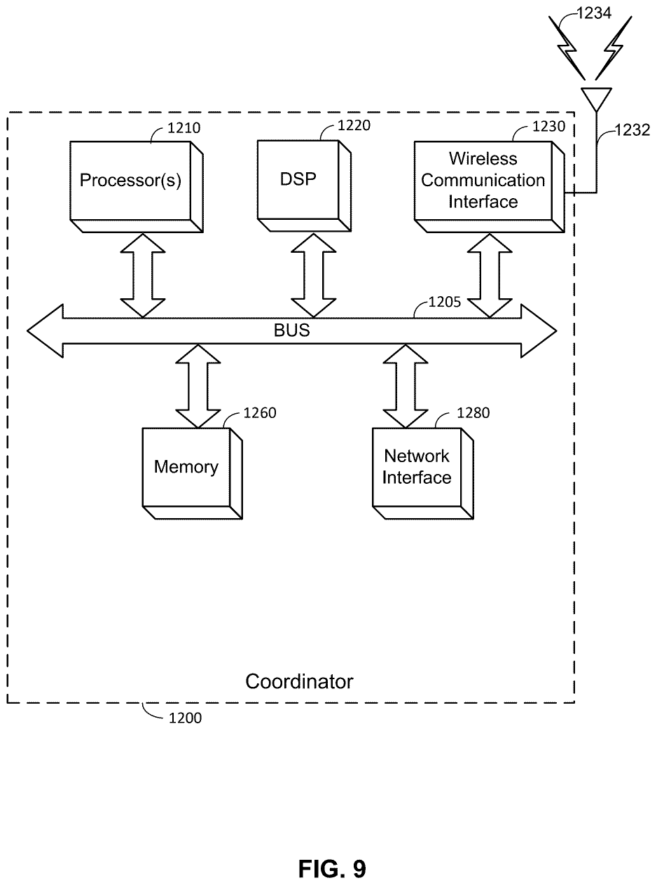

FIG. 6 is a flow diagram of a coordinator-implemented method 600 of wake time negotiation in a LR-WPAN, according to some implementations. Means for performing the functionality illustrated in one or more of the blocks shown in FIG. 6 may be performed by hardware and/or software components of a coordinator. Example components of a coordinator are illustrated in FIG. 9, which is described in more detail below. In FIG. 6, at block 610, following establishment of a LR-WPAN association between a coordinator and an end device, the functionality comprises the coordinator transmitting an initiator communication indicating at least an enablement of the wake time negotiation. At block 620, the functionality comprises the coordinator receiving a responder communication indicating at least: the enablement of the wake time negotiation, and a feasible timeframe for the end device to participate in a data transaction with the coordinator. At block 630, the functionality comprises the coordinator determining an intended service timeframe to participate in the data transaction with the end device. For example, block 630 can include determining whether the feasible service timeframe is available using a service schedule maintained in a memory and identifying a plurality of scheduled service timeframes for one or more end devices having the LR-WPAN association with the coordinator. At block 640, the functionality comprises the coordinator scheduling the intended service timeframe. At block 650, the functionality comprises the coordinator transmitting a coordinator acknowledgment communication indicating at least the scheduled service timeframe. Means for performing functionality at blocks 610 through 650 may comprise components of a coordinator, as illustrated in FIG. 9.

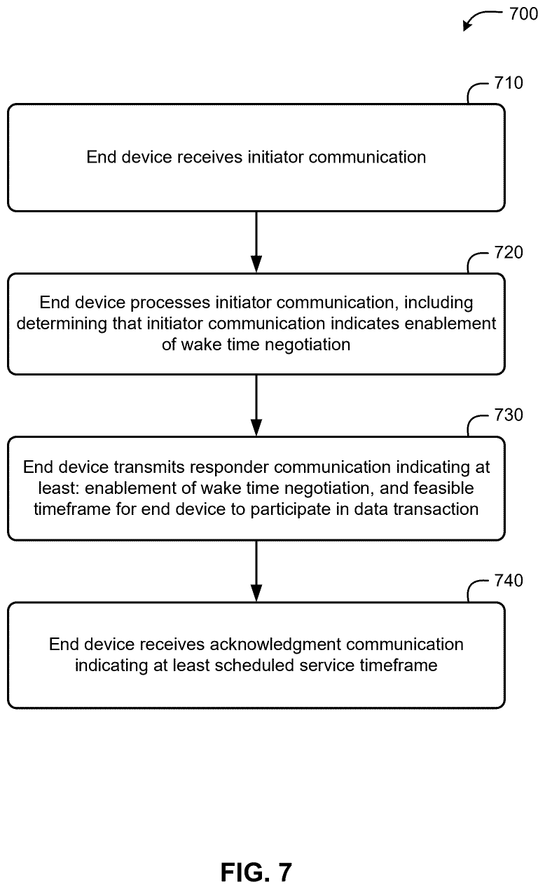

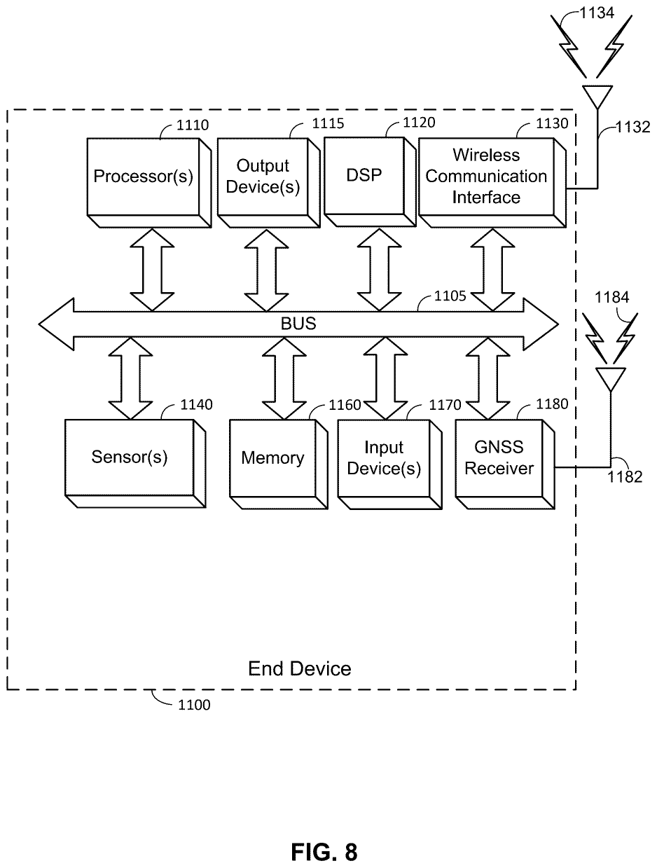

FIG. 7 is a flow diagram of an end device-implemented method 700 of wake time negotiation in a LR-WPAN, according to some implementations. Means for performing the functionality illustrated in one or more of the blocks shown in FIG. 7 may be performed by hardware and/or software components of an end device. Example components of an end device are illustrated in FIG. 8, which is described in more detail below. In FIG. 7, at block 710, following establishment of a LR-WPAN association between a coordinator and an end device, the functionality comprises the end device receiving an initiator communication. At block 720, the functionality comprises the end device processing the initiator communication, including determining that the initiator communication indicates at least an enablement of the wake time negotiation. At block 730, the functionality comprises the end device transmitting a responder communication indicating at least: the enablement of the wake time negotiation, and a feasible timeframe for the end device to participate in a data transaction with the coordinator. At block 740, the functionality comprises the end device receiving a coordinator acknowledgment communication indicating at least a scheduled service timeframe. Means for performing functionality at blocks 710 through 740 may comprise components of an end device, as illustrated in FIG. 8.

FIG. 8 is a block diagram of an example of an end device 1100, which can be utilized in some implementations as described herein above (e.g., in association with FIGS. 1-7). For example, the end device 1100 can perform one or more of the functions of the method shown in FIG. 7. It should be noted that FIG. 8 is meant only to provide a generalized illustration of various components, any or all of which may be utilized as appropriate. It can be noted that, in some instances, components illustrated by FIG. 8 can be localized to a single physical device and/or distributed among various networked devices, which may be disposed at different physical locations. Furthermore, as previously noted, the functionality of the end device discussed in the previously described embodiments may be executed by one or more of the hardware and/or software components illustrated in FIG. 8.

The end device 1100 is shown comprising hardware elements that can be electrically coupled via a bus 1105 (or may otherwise be in communication, as appropriate). The hardware elements may include a processor(s) 1110 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1110 may comprise one or more processing units, which may be housed in a single integrated circuit (IC) or multiple ICs. As shown in FIG. 8, some embodiments may have a separate DSP 1120, depending on desired functionality. Location determination and/or other determinations based on wireless communication may be provided in the processor(s) 1110 and/or wireless communication interface 1130 (discussed below). The end device 1100 also can include one or more input devices 1170, which can include without limitation one or more keyboards, touch screens, touch pads, microphones, buttons, dials, switches, and/or the like; and one or more output devices 1115, which can include without limitation one or more displays (e.g., touch screens), light emitting diodes (LEDs), speakers, and/or the like.

The end device 1100 may also include a wireless communication interface 1130, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the end device 1100 to communicate with other devices as described in the embodiments above. The wireless communication interface 1130 may permit data and signaling to be communicated (e.g., transmitted and received) with TRPs of a network, for example, via eNBs, gNBs, ng-eNBs, access points, various coordinators and/or other access node types, and/or other network components, computer systems, and/or any other electronic devices communicatively coupled with TRPs, as described herein. The communication can be carried out via one or more wireless communication antenna(s) 1132 that send and/or receive wireless signals 1134. According to some embodiments, the wireless communication antenna(s) 1132 may comprise a plurality of discrete antennas, antenna arrays, or any combination thereof. The antenna(s) 1132 may be capable of transmitting and receiving wireless signals using beams (e.g., Tx beams and Rx beams). Beam formation may be performed using digital and/or analog beam formation techniques, with respective digital and/or analog circuitry. The wireless communication interface 1130 may include such circuitry.

Depending on desired functionality, the wireless communication interface 1130 may comprise a separate receiver and transmitter, or any combination of transceivers, transmitters, and/or receivers to communicate with coordinators (e.g., ng-eNBs and gNBs) and other terrestrial transceivers, such as wireless devices and access points. The end device 1100 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The end device 1100 can further include sensor(s) 1140. Sensor(s) 1140 may comprise, without limitation, one or more inertial sensors and/or other sensors (e.g., accelerometer(s), gyroscope(s), camera(s), magnetometer(s), altimeter(s), microphone(s), proximity sensor(s), light sensor(s) (e.g., lidar), infrared sensor(s), RF sensor(s) (e.g., radar), barometer(s), and the like), some of which may be used to obtain position-related measurements and/or other information. In some configurations, the sensor(s) 1140 may not be co-located with the end device 1100, e.g., communicatively coupled (wired or wirelessly) but not disposed at the end device 1100.

Embodiments of the end device 1100 may also include a Global Navigation Satellite System (GNSS) receiver 1180 capable of receiving signals 1184 from one or more GNSS satellites using an antenna 1182 (which could be the same as antenna 1132). Positioning based on GNSS signal measurement can be utilized to complement and/or incorporate the techniques described herein. The GNSS receiver 1180 can extract a position of the end device 1100, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1180 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1180 is illustrated in FIG. 8 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1110, DSP 1120, and/or a processor within the wireless communication interface 1130 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1110 or DSP 1120.

The end device 1100 may further include and/or be in communication with a memory 1160. The memory 1160 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1160 of the end device 1100 also can comprise software elements (not shown in FIG. 8), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1160 that are executable by the end device 1100 (and/or processor(s) 1110 or DSP 1120 within end device 1100). In some embodiments, then, such code and/or instructions can be used to configure and/or adapt a general-purpose computer (or other device) to perform one or more operations in accordance with the described methods.

FIG. 9 is a block diagram of an example of a coordinator 1200, which can be utilized in some implementations as described herein above (e.g., in association with FIGS. 1-7). For example, the coordinator 1200 can perform one or more of the functions of the method shown in FIG. 6. It should be noted that FIG. 9 is meant only to provide a generalized illustration of various components, any or all of which may be utilized as appropriate. It can be noted that, in some instances, components illustrated by FIG. 9 can be localized to a single physical device and/or distributed among various networked devices, which may be disposed at different physical locations. Furthermore, as previously noted, the functionality of the coordinator discussed in the previously described embodiments may be executed by one or more of the hardware and/or software components illustrated in FIG. 9. In some embodiments, the coordinator 1200 may correspond to a gNB, an ng-eNB, and/or (more generally) a TRP.

The coordinator 1200 is shown comprising hardware elements that can be electrically coupled via a bus 1205 (or may otherwise be in communication, as appropriate). The hardware elements may include a processor(s) 1210 which can include without limitation one or more general-purpose processors, one or more special-purpose processors (such as DSP chips, graphics acceleration processors, ASICs, and/or the like), and/or other processing structure or means. As shown in FIG. 9, some embodiments may have a separate DSP 1220, depending on desired functionality. Location determination and/or other determinations based on wireless communication may be provided in the processor(s) 1210 and/or wireless communication interface 1230 (discussed below), according to some embodiments. The coordinator 1200 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The coordinator 1200 might also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the coordinator 1200 to communicate as described herein. The wireless communication interface 1230 may permit data and signaling to be communicated (e.g., transmitted and received) to end devices, other coordinators/TRPs (e.g., eNBs, gNBs, and ng-eNBs), and/or other network components, computer systems, and/or any other electronic devices described herein. The communication can be carried out via one or more wireless communication antenna(s) 1232 that send and/or receive wireless signals 1234.

The coordinator 1200 may also include a network interface 1280, which can include support of wireline communication technologies. The network interface 1280 may include a modem, network card, chipset, and/or the like. The network interface 1280 may include one or more input and/or output communication interfaces to permit data to be exchanged with a network, communication network servers, computer systems, and/or any other electronic devices described herein.

In many embodiments, the coordinator 1200 may further comprise a memory 1260. The memory 1260 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1260 of the coordinator 1200 also may comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the coordinator 1200 (and/or processor(s) 1210 or DSP 1220 within coordinator 1200). In some embodiments, then, such code and/or instructions can be used to configure and/or adapt a general-purpose computer (or other device) to perform one or more operations in accordance with the described methods.

The coordinator 1200 may also include one or more sensor(s) 1240. Sensor(s) 1140 may include, without limitation, one or more inertial sensors and/or other sensors (e.g., accelerometer(s), gyroscope(s), camera(s), magnetometer(s), altimeter(s), microphone(s), proximity sensor(s), light sensor(s) (e.g., lidar), infrared sensor(s), RF sensor(s) (e.g., radar), barometer(s), and the like), some of which may be used to obtain position-related measurements and/or other information. In some configurations, the sensor(s) 1240 may not be co-located with the coordinator 1200, e.g., communicatively coupled (wired or wirelessly) but not disposed at the coordinator 1200.

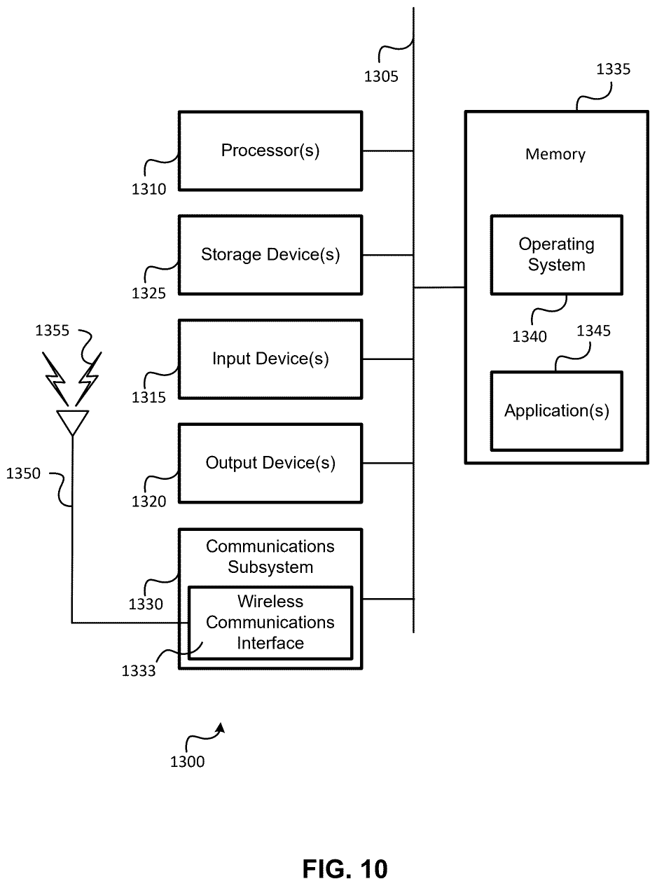

FIG. 10 is a block diagram of an example of a computer system 1300, which can be utilized in some implementations. Computer system 1300 may be used, in whole or in part, to provide the functions of one or more network components as described in the embodiments herein. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner. In addition, it can be noted that components illustrated by FIG. 10 can be localized to a single device and/or distributed among various networked devices, which may be disposed at different geographical locations.

The computer system 1300 is shown comprising hardware elements that can be electrically coupled via a bus 1305 (or may otherwise be in communication, as appropriate). The hardware elements may include processor(s) 1310, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1300 also may comprise one or more input devices 1315, which may comprise without limitation a mouse, a keyboard, a camera, a microphone, and/or the like; and one or more output devices 1320, which may comprise without limitation a display device, a printer, and/or the like.

The computer system 1300 may further include (and/or be in communication with) one or more non-transitory storage devices 1325, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1300 may also include a communications subsystem 1330, which may comprise wireless communication technologies managed and controlled by a wireless communication interface 1333, as well as wired technologies (such as Ethernet, coaxial communications, universal serial bus (USB), and the like). The wireless communication interface 1333 may comprise one or more wireless transceivers that may send and receive wireless signals 1355 (e.g., signals according to 5G NR or LTE) via wireless antenna(s) 1350. Thus the communications subsystem 1330 may comprise a modem, a network card (wireless or wired), an infrared communication device, a wireless communication device, and/or a chipset, and/or the like, which may enable the computer system 1300 to communicate on any or all of the communication networks described herein to any device on the respective network, including end devices, coordinators and/or other TRPs, and/or any other electronic devices described herein. Hence, the communications subsystem 1330 may be used to receive and send data as described in the embodiments herein.

In many embodiments, the computer system 1300 will further comprise a working memory 1335, which may comprise a RAM or ROM device, as described above. Software elements, shown as being located within the working memory 1335, may comprise an operating system 1340, device drivers, executable libraries, and/or other code, such as one or more applications 1345, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1325 described above. In some cases, the storage medium might be incorporated within a computer system, such as computer system 1300. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1300 and/or might take the form of source and/or installable code, which, upon compilation and/or installation on the computer system 1300 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description, embodiments may include different combinations of features. Implementation examples are described in the following numbered clauses:
Clause 1. A coordinator-implemented method of wake time negotiation in a low-rate wireless personal area network (LR-WPAN), the method comprising: following establishment of a LR-WPAN association between the coordinator and an end device: transmitting, using the LR-WPAN, an initiator communication indicating at least an enablement of the wake time negotiation; receiving, using the LR-WPAN, a responder communication indicating at least: the enablement of the wake time negotiation, and a feasible timeframe for the end device to participate in a data transaction with the coordinator; determining an intended service timeframe to participate in the data transaction with the end device; scheduling the intended service timeframe for the end device; and transmitting, using the LR-WPAN, a coordinator acknowledgment communication indicating at least the scheduled service timeframe.
Clause 2. The method of clause 1, further comprising: entering into a sleep mode from an awake mode after transmitting the coordinator acknowledgment communication; or entering into the sleep mode from the awake mode after the scheduled service timeframe; or a combination thereof.
Clause 3. The method of clause 1 or 2, wherein determining the intended service timeframe to participate in the data transaction with the end device includes: determining that the feasible service timeframe is available using a service schedule maintained in a memory and identifying a plurality of scheduled service timeframes for one or more end devices having the LR-WPAN association with the coordinator; and designating the feasible service timeframe as the intended service timeframe.
Clause 4. The method of clause 1 or 2, wherein determining the intended service timeframe to participate in the data transaction with the end device includes: determining that the feasible service timeframe is unavailable using a service schedule maintained in a memory and identifying a plurality of scheduled service timeframes for one or more end devices having the LR-WPAN association with the coordinator; determining, using the service schedule, an available service timeframe; transmitting, using the LR-WPAN, an available service communication indicating the available service timeframe; receiving, using the LR-WPAN, an end device acknowledgement communication indicating acceptance of the available service timeframe; and designating the available service timeframe as the intended service timeframe.
Clause 5. The method of clause 1 or 2, further comprising: maintaining a service schedule in a memory to include identifications of a plurality of scheduled service timeframes for one or more end devices having the LR-WPAN association with the coordinator, wherein scheduling the intended service timeframe for the end device includes updating the service schedule.
Clause 6. The method of any of clauses 1-5, further comprising: generating the initiator communication to indicate the enablement of the wake time negotiation and further indicate: an address of the coordinator, clock data of the coordinator, a next available service timeframe for the coordinator to participate in the data transaction, or a channel, or a combination thereof.
Clause 7. The method of any of clauses 1-6, further comprising: determining that the responder communication indicates the enablement of the wake time negotiation and the feasible timeframe for the end device to participate in the data transaction with the coordinator, and further indicates: a network identifier (ID) of the end device, clock data of the end device, or a channel, or a combination thereof.
Clause 8. The method of any of clauses 1-7, further comprising: participating, using the LR-WPAN, in the data transaction with the end device during the scheduled service timeframe.
Clause 9. A coordinator comprising: one or more transceivers; one or more memories; and one or more processors communicatively coupled with the one or more memories and the one or more transceivers, the one or more processors configured to: following establishment of a LR-WPAN association between the coordinator and an end device: transmit, using the LR-WPAN, an initiator communication indicating at least an enablement of the wake time negotiation; receive, using the LR-WPAN, a responder communication indicating at least: the enablement of the wake time negotiation, and a feasible timeframe for the end device to participate in a data transaction with the coordinator; determine an intended service timeframe to participate in the data transaction with the end device; schedule the intended service timeframe for the end device; and transmit, using the LR-WPAN, a coordinator acknowledgment communication indicating at least the scheduled service timeframe.
Clause 10. The coordinator of clause 9, the one or more processors further configured to: enter into a sleep mode from an awake mode after transmitting the coordinator acknowledgment communication; or enter into the sleep mode from the awake mode after the scheduled service timeframe. or a combination thereof.
Clause 11. The coordinator of clause 9 or 10, wherein, to determine the intended service timeframe to participate in the data transaction with the end device, the one or more processors is or are configured to: determine that the feasible service timeframe is available using a service schedule maintained in a memory and identifying a plurality of scheduled service timeframes for one or more end devices having the LR-WPAN association with the coordinator; and designate the feasible service timeframe as the intended service timeframe.
Clause 12. The coordinator of clause 9 or 10, wherein, to determine the intended service timeframe to participate in the data transaction with the end device, the one or more processors is or are configured to: determine that the feasible service timeframe is unavailable using a service schedule maintained in a memory and identifying a plurality of scheduled service timeframes for one or more end devices having the LR-WPAN association with the coordinator; determine, using the service schedule, an available service timeframe; transmit, using the LR-WPAN, an available service communication indicating the available service timeframe; receive, using the LR-WPAN, an end device acknowledgement communication indicating acceptance of the available service timeframe; and designate the available service timeframe as the intended service timeframe.
Clause 13. The coordinator of clause 9 or 10, the one or more processors further configured to: maintain a service schedule in a memory to include identifications of a plurality of scheduled service timeframes for one or more end devices having the LR-WPAN association with the coordinator, wherein scheduling the intended service timeframe for the end device includes updating the service schedule.
Clause 14. The coordinator of any of clauses 9-13, the one or more processors further configured to: generate the initiator communication to indicate the enablement of the wake time negotiation and further indicate: an address of the coordinator, clock data of the coordinator, a next available service timeframe for the coordinator to participate in the data transaction, or a channel, or a combination thereof.
Clause 15. The coordinator of any of clauses 9-14, the one or more processors further configured to: determine that the responder communication indicates the enablement of the wake time negotiation and the feasible timeframe for the end device to participate in the data transaction with the coordinator, and further indicates: a network identifier (ID) of the end device, clock data of the end device, or a channel, or a combination thereof.
Clause 16. An end device-implemented method of wake time negotiation in a low-rate wireless personal area network (LR-WPAN), the method comprising: following establishment of a LR-WPAN association between a coordinator and the end device: receiving, using the LR-WPAN, an initiator communication; processing the initiator communication, including determining that the initiator communication indicates an enablement of the wake time negotiation; transmitting, using the LR-WPAN, a responder communication indicating at least: the enablement of the wake time negotiation, and a feasible timeframe for the end device to participate in a data transaction with the coordinator; and receiving, using the LR-WPAN, a coordinator acknowledgment communication indicating at least a scheduled service timeframe.
Clause 17. The method of clause 16, further comprising: entering into a sleep mode from an awake mode after receiving the coordinator acknowledgment communication; or entering into the sleep mode from the awake mode after the scheduled service timeframe; or a combination thereof.
Clause 18. The method of clause 16 or 17, further comprising: scheduling one or more wake-up events based on the scheduled service timeframe.
Clause 19. The method of any of clauses 16-18, further comprising: receiving, using the LR-WPAN, an available service communication indicating an available service timeframe for the coordinator; determining that the available service timeframe is feasible for the end device; and transmitting, using the LR-WPAN, an end device acknowledgement communication indicating acceptance of the available service timeframe.
Clause 20. The method of any of clauses 16-19, wherein processing the initiator communication further includes: determining that the initiator communication further indicates: an address of the coordinator, clock data of the coordinator, a next available service timeframe for the coordinator to participate in the data transaction, or a channel, or a combination thereof.
Clause 21. The method of clause 20, further comprising: comparing the clock data of the coordinator with clock data of the end device; comparing the next available service timeframe with the feasible timeframe; or determining the feasible timeframe based on the next available service timeframe; or a combination thereof.
Clause 22. The method of any of clauses 16-21, further comprising: generating the responder communication to indicate the enablement of the wake time negotiation and the feasible timeframe for the end device to participate in the data transaction with the coordinator, and further indicate: a network identifier (ID) of the end device, clock data of the end device, or a channel, or a combination thereof.
Clause 23. The method of any of clauses 16-22, further comprising: participating, using the LR-WPAN, in the data transaction with the coordinator during the scheduled service timeframe.
Clause 24. An end device comprising: one or more transceivers; one or more memories; and one or more processors communicatively coupled with the one or more memories and the one or more transceivers, the one or more processors configured to: following establishment of a LR-WPAN association between a coordinator and the end device: receive, using the LR-WPAN, an initiator communication; process the initiator communication, including determining that the initiator communication indicates an enablement of the wake time negotiation; transmit, using the LR-WPAN, a responder communication indicating at least: the enablement of the wake time negotiation, and a feasible timeframe for the end device to participate in a data transaction with the coordinator; and receive, using the LR-WPAN, a coordinator acknowledgment communication indicating at least a scheduled service timeframe.
Clause 25. The end device of clause 24, the one or more processors further configured to: enter into a sleep mode from an awake mode after receiving the coordinator acknowledgment communication; or enter into the sleep mode from the awake mode after the scheduled service timeframe; or a combination thereof.
Clause 26. The end device of clause 24 or 25, the one or more processors further configured to: schedule one or more wake-up events based on the scheduled service timeframe.
Clause 27. The end device of any of clauses 24-26, the one or more processors further configured to: receive, using the LR-WPAN, an available service communication indicating an available service timeframe for the coordinator; determine that the available service timeframe is feasible for the end device; and transmit, using the LR-WPAN, an end device acknowledgement communication indicating acceptance of the available service timeframe.
Clause 28. The end device of any of clauses 24-27, wherein, to process the initiator communication, the one or more processors is or are further configured to: determine that the initiator communication further indicates: an address of the coordinator, clock data of the coordinator, a next available service timeframe for the coordinator to participate in the data transaction, or a channel, or a combination thereof.
Clause 29. The end device of clause 28, the one or more processors further configured to: compare the clock data of the coordinator with clock data of the end device; compare the next available service timeframe with the feasible timeframe; or determine the feasible timeframe based on the next available service timeframe; or a combination thereof.
Clause 30. The end device of any of clauses 24-29, the one or more processors further configured to: generate the responder communication to indicate the enablement of the wake time negotiation and the feasible timeframe for the end device to participate in the data transaction with the coordinator, and further indicate: a network identifier (ID) of the end device, clock data of the end device, or a channel, or a combination thereof.

What is claimed is:

1. A coordinator-implemented method of wake time negotiation in a low-rate wireless personal area network (LR-WPAN), the method comprising:
following establishment of a LR-WPAN association between the coordinator and an end device:
transmitting, using the LR-WPAN, an initiator communication indicating at least an enablement of the wake time negotiation;
receiving, using the LR-WPAN, a responder communication indicating at least:
the enablement of the wake time negotiation, and a feasible timeframe for the end device to participate in a data transaction with the coordinator;
determining an intended service timeframe to participate in the data transaction with the end device;
scheduling the intended service timeframe for the end device; and
transmitting, using the LR-WPAN, a coordinator acknowledgment communication indicating at least the scheduled service timeframe.

2. The method of claim 1, further comprising:
entering into a sleep mode from an awake mode after transmitting the coordinator acknowledgment communication; or
entering into the sleep mode from the awake mode after the scheduled service timeframe;
or a combination thereof.

3. The method of claim 1, wherein determining the intended service timeframe to participate in the data transaction with the end device includes:
determining that the feasible service timeframe is available using a service schedule maintained in a memory and identifying a plurality of scheduled service timeframes for one or more end devices having the LR-WPAN association with the coordinator; and
designating the feasible service timeframe as the intended service timeframe.

4. The method of claim 1, wherein determining the intended service timeframe to participate in the data transaction with the end device includes:
determining that the feasible service timeframe is unavailable using a service schedule maintained in a memory and identifying a plurality of scheduled service timeframes for one or more end devices having the LR-WPAN association with the coordinator;
determining, using the service schedule, an available service timeframe; transmitting, using the LR-WPAN, an available service communication indicating the available service timeframe;
receiving, using the LR-WPAN, an end device acknowledgement communication indicating acceptance of the available service timeframe; and
designating the available service timeframe as the intended service timeframe.

5. The method of claim 1, further comprising:
maintaining a service schedule in a memory to include identifications of a plurality of scheduled service timeframes for one or more end devices having the LR-WPAN association with the coordinator, wherein scheduling the intended service timeframe for the end device includes updating the service schedule.

6. The method of claim 1, further comprising:
generating the initiator communication to indicate the enablement of the wake time negotiation and further indicate: an address of the coordinator, clock data of the coordinator, a next available service timeframe for the coordinator to participate in the data transaction, or a channel, or a combination thereof.

7. The method of claim 1, further comprising:
determining that the responder communication indicates the enablement of the wake time negotiation and the feasible timeframe for the end device to participate in the data transaction with the coordinator, and further indicates: a network identifier (ID) of the end device, clock data of the end device, or a channel, or a combination thereof.

8. The method of claim 1, further comprising:
participating, using the LR-WPAN, in the data transaction with the end device during the scheduled service timeframe.

9. A coordinator comprising:
one or more transceivers;
one or more memories; and
one or more processors communicatively coupled with the one or more memories and the one or more transceivers, the one or more processors configured to:
following establishment of a LR-WPAN association between the coordinator and an end device:
transmit, using the LR-WPAN, an initiator communication indicating at least an enablement of the wake time negotiation;
receive, using the LR-WPAN, a responder communication indicating at least: the enablement of the wake time negotiation, and a feasible timeframe for the end device to participate in a data transaction with the coordinator;
determine an intended service timeframe to participate in the data transaction with the end device;
schedule the intended service timeframe for the end device; and
transmit, using the LR-WPAN, a coordinator acknowledgment communication indicating at least the scheduled service timeframe.

10. The coordinator of claim 9, the one or more processors further configured to:
enter into a sleep mode from an awake mode after transmitting the coordinator acknowledgment communication; or
enter into the sleep mode from the awake mode after the scheduled service timeframe;
or a combination thereof.

11. The coordinator of claim 9, wherein, to determine the intended service timeframe to participate in the data transaction with the end device, the one or more processors is or are configured to:
determine that the feasible service timeframe is available using a service schedule maintained in a memory and identifying a plurality of scheduled service timeframes for one or more end devices having the LR-WPAN association with the coordinator; and
designate the feasible service timeframe as the intended service timeframe.

12. The coordinator of claim 9, wherein, to determine the intended service timeframe to participate in the data transaction with the end device, the one or more processors is or are configured to:
determine that the feasible service timeframe is unavailable using a service schedule maintained in a memory and identifying a plurality of scheduled service timeframes for one or more end devices having the LR-WPAN association with the coordinator;
determine, using the service schedule, an available service timeframe;
transmit, using the LR-WPAN, an available service communication indicating the available service timeframe;
receive, using the LR-WPAN, an end device acknowledgement communication indicating acceptance of the available service timeframe; and
designate the available service timeframe as the intended service timeframe.

13. The coordinator of claim 9, the one or more processors further configured to:
maintain a service schedule in a memory to include identifications of a plurality of scheduled service timeframes for one or more end devices having the LR-WPAN association with the coordinator, wherein scheduling the intended service timeframe for the end device includes updating the service schedule.

14. The coordinator of claim 9, the one or more processors further configured to:
generate the initiator communication to indicate the enablement of the wake time negotiation and further indicate: an address of the coordinator, clock data of the coordinator, a next available service timeframe for the coordinator to participate in the data transaction, or a channel, or a combination thereof.

15. The coordinator of claim 9, the one or more processors further configured to:
determine that the responder communication indicates the enablement of the wake time negotiation and the feasible timeframe for the end device to participate in the data transaction with the coordinator, and further indicates: a network identifier (ID) of the end device, clock data of the end device, or a channel, or a combination thereof.

16. An end device-implemented method of wake time negotiation in a low-rate wireless personal area network (LR-WPAN), the method comprising:
following establishment of a LR-WPAN association between a coordinator and the end device:
receiving, using the LR-WPAN, an initiator communication;
processing the initiator communication, including determining that the initiator communication indicates an enablement of the wake time negotiation;
transmitting, using the LR-WPAN, a responder communication indicating at least: the enablement of the wake time negotiation, and a feasible timeframe for the end device to participate in a data transaction with the coordinator; and
receiving, using the LR-WPAN, a coordinator acknowledgment communication indicating at least a scheduled service timeframe.

17. The method of claim 16, further comprising:
entering into a sleep mode from an awake mode after receiving the coordinator acknowledgment communication; or
entering into the sleep mode from the awake mode after the scheduled service timeframe;
or a combination thereof.

18. The method of claim 16, further comprising:
scheduling one or more wake-up events based on the scheduled service timeframe.

19. The method of claim 16, further comprising:
receiving, using the LR-WPAN, an available service communication indicating an available service timeframe for the coordinator;
determining that the available service timeframe is feasible for the end device; and
transmitting, using the LR-WPAN, an end device acknowledgement communication indicating acceptance of the available service timeframe.

20. The method of claim 16, wherein processing the initiator communication further includes:
determining that the initiator communication further indicates: an address of the coordinator, clock data of the coordinator, a next available service timeframe for the coordinator to participate in the data transaction, or a channel, or a combination thereof.

21. The method of claim 20, further comprising:
comparing the clock data of the coordinator with clock data of the end device;
comparing the next available service timeframe with the feasible timeframe; or
determining the feasible timeframe based on the next available service timeframe;
or a combination thereof.

22. The method of claim 16, further comprising:
generating the responder communication to indicate the enablement of the wake time negotiation and the feasible timeframe for the end device to participate in the data transaction with the coordinator, and further indicate: a network identifier (ID) of the end device, clock data of the end device, or a channel, or a combination thereof.

23. The method of claim 16, further comprising:
participating, using the LR-WPAN, in the data transaction with the coordinator during the scheduled service timeframe.

24. An end device comprising:
one or more transceivers;
one or more memories; and
one or more processors communicatively coupled with the one or more memories and the one or more transceivers, the one or more processors configured to:
following establishment of a LR-WPAN association between a coordinator and the end device:
receive, using the LR-WPAN, an initiator communication;
process the initiator communication, including determining that the initiator communication indicates an enablement of the wake time negotiation;
transmit, using the LR-WPAN, a responder communication indicating at least:
the enablement of the wake time negotiation, and a feasible timeframe for the end device to participate in a data transaction with the coordinator; and
receive, using the LR-WPAN, a coordinator acknowledgment communication indicating at least a scheduled service timeframe.

25. The end device of claim 24, the one or more processors further configured to:
enter into a sleep mode from an awake mode after receiving the coordinator acknowledgment communication; or
enter into the sleep mode from the awake mode after the scheduled service timeframe;
or a combination thereof.

26. The end device of claim 24, the one or more processors further configured to:
schedule one or more wake-up events based on the scheduled service timeframe.

27. The end device of claim 24, the one or more processors further configured to:
receive, using the LR-WPAN, an available service communication indicating an available service timeframe for the coordinator;
determine that the available service timeframe is feasible for the end device; and
transmit, using the LR-WPAN, an end device acknowledgement communication indicating acceptance of the available service timeframe.

28. The end device of claim 24, wherein, to process the initiator communication, the one or more processors is or are further configured to:
determine that the initiator communication further indicates: an address of the coordinator, clock data of the coordinator, a next available service timeframe for the coordinator to participate in the data transaction, or a channel, or a combination thereof.

29. The end device of claim 28, the one or more processors further configured to:
compare the clock data of the coordinator with clock data of the end device;
compare the next available service timeframe with the feasible timeframe; or determine the feasible timeframe based on the next available service timeframe;
or a combination thereof.

30. The end device of claim 24, the one or more processors further configured to:
generate the responder communication to indicate the enablement of the wake time negotiation and the feasible timeframe for the end device to participate in the data transaction with the coordinator, and further indicate: a network identifier (ID) of the end device, clock data of the end device, or a channel, or a combination thereof.
